(19) United States
(12) Patent Application Publication
(10) Pub. No.: US 2022/0237548 A1
(43) Pub. Date: Jul. 28, 2022

(54) GAMIFIED REAL-TIME ARTIFICIAL INTELLIGENCE BASED INDIVIDUALIZED ADAPTIVE LEARNING

(71) Applicant: Right-Hand Cyber Security Pte. Ltd., Singapore (SG)

(72) Inventor: Uzair Ahmed GILANI, Singapore (SG)

(21) Appl. No.: 17/213,536

(22) Filed: Mar. 26, 2021

Related U.S. Application Data
(60) Provisional application No. 63/142,513, filed on Jan. 28, 2021.

(51) Int. Cl. G06Q 10/06; G06N 5/02; G06N 3/08

(52) U.S. Cl. CPC G06Q 10/063112; G06N 3/08; G06N 5/025; G06N 5/022

(57) ABSTRACT

The present disclosure describes methods and systems to provide gamified real-time AI based adaptive learning. The system may receive a set of nodes and directed edges connecting the nodes representing a general knowledge graph; receive user attribute information; organize users into gamification driver type groups and associate at least one gamification trigger to each gamification driver type; determine a current knowledge level of the user; determine a set of candidate nodes; use a neural network to select one node from the set of candidate nodes based on the current knowledge level of the user; provide the node to the user with at least one gamification trigger; determine, when the user performs an activity associated with the node, performance attributes related to the activity; update the current knowledge level of the user based on the performance attributes; and adapt the learning path of the user based on the current knowledge level.

### CROSS-REFERENCE TO RELATED APPLICATIONS

The present application claims priority to U.S. Provisional Patent Application Ser. No. 63/142,513, filed on Jan. 28, 2021.

### TECHNICAL FIELD

The present disclosure relates to adaptive learning, e.g., to using artificial intelligence (AI) and gamification to improve adaptive learning.

### BACKGROUND

Various embodiments generally may relate to the field of AI based adaptive learning.

### BRIEF DESCRIPTION OF THE DRAWINGS

Various aspects of the present disclosure are explained below by means of various embodiments with reference to the following drawings. The figures are not necessarily drawn to scale. Throughout the figures, identical or similar components are provided with the same reference signs.

FIG. 1 illustrates a component flow diagram of a process for determining a learning path and a gamification trigger in accordance with various aspects of the present disclosure.

FIG. 2 illustrates a logical diagram of an Expert Model of FIG. 1 in accordance with various aspects of the present disclosure.

FIG. 3 illustrates a logical diagram of a User Model of FIG. 1 in accordance with various aspects of the present disclosure.

FIG. 4 illustrates a logical diagram of a Tutor Model of FIG. 1 in accordance with various aspects of the present disclosure.

FIG. 5 illustrates a logical diagram of a Gamification Model of FIG. 1 in accordance with various embodiments.

FIG. 6 illustrates a detailed logical flow diagram of a process for determining a learning path in accordance with various aspects of the present disclosure.

FIGS. 7A and 7B illustrate examples of knowledge graphs and customized learner paths in accordance with various aspects of the present disclosure.

FIG. 8 illustrates a more detailed logical flow diagram of a process for determining a learning path and a gamification trigger in accordance with various aspects of the present disclosure.

FIG. 9 illustrates a logical flow diagram of a process for determining repeated activities and repetition intervals in accordance with various aspects of the present disclosure.

FIG. 10 is a block diagram illustrating components, according to some example embodiments, able to read instructions from a machine-readable or computer-readable medium (e.g., a non-transitory machine-readable storage medium) and perform any one or more of the methodologies discussed herein.

FIG. 11 illustrates a table showing attributes maintained for two learners by the User Model.

FIGS. 12A-D illustrate tables showing attributes maintained by the User Model.

FIG. 13 illustrates a graph and table showing a general knowledge graph and activity attributes maintained by the Expert Model.

FIG. 14 illustrates a table showing gamification drivers and associated triggers maintained by the Gamification Model.

### DETAILED DESCRIPTION

The following detailed description refers to the accompanying drawings that show, by way of illustration, example details and aspects in which the present disclosure may be practiced. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

In large and small companies alike, current and new employees require constant training to work efficiently while complying with the company's standards (e.g., security, safety, customer interaction). Training programs and their effectiveness are one of the highest priorities of companies everywhere. Therefore, the method and success rates of the training program cannot be understated.

This is especially important for training programs related to raising cybersecurity awareness. A not-so-well known statistic is that around 90% of data breaches actually occur due to human error. Between 2013 and 2015, Google and Facebook collectively lost over a $100 million due to phishing email posing as invoices. Therefore, cybersecurity training is essential as it can save the company from potentially losing millions of dollars by minimizing the risks of data breaches.

In the past, companies have used different ways of traditional teaching techniques to achieve these learning goals (e.g., slide presentations, videos, or in-class training), but they found these training mediums to be ineffective or only partially effective. The major reason behind the failures of these approaches is human behavior. The learning path of every person is different, so a one size fits all approach does not work effectively for everyone. Another reason why these approaches were not effective is the variable retention time of these concepts by the trainees as companies were training their employees on an annual or bi-annual basis. Some employees were able to retain the information for longer periods of time than others.

The lack of knowledge retention is a chronic problem that is faced in the corporate training environment. Knowledge retention refers to how well learners remember knowledge. In businesses, knowledge retention also refers to how well the combined knowledge is preserved over time. The trend in instructional design is to create chunks of learning content known as learning objects to make chunks of training reusable, but it does not address knowledge retention or maintaining learner attention. The importance of knowledge retention cannot be understated, especially in the corporate world. Something common amongst the aforementioned breaches was that most human errors could be traced to lack of knowledge retention.

The reason that companies have not addressed these deficiencies is because the process of identifying each person's knowledge gap can be quite tedious and costly for any human to do and impossible for any human to do in real-time. Furthermore, in order to improve retention rates, the trainings will have to be done more frequently. Since the training programs are optimized to save money and time, the issue goes unresolved because customized and more frequent training programs are expensive and incredibly resource intensive.

Adaptive learning may be used to address the existing shortcomings of traditional teaching techniques. Adaptive learning utilizes technology and data to deliver education and/or training through a customized learning path to each individual user. Adaptive learning addresses the problem of the one-size-fits-all approach of traditional training programs.

For example, some adaptive learning technology has proven effective for educational institutes as it has been shown to help students to retain their knowledge for a longer period. This can be seen in the partnership between Arizona State University and Knewton (an adaptive learning platform for students) which showed an increase by 18% in pass rates and a decrease of 47% in withdrawal rates for math papers.

Adaptive learning may also be effective for companies as it can address the aforementioned problems of different employees having different learning styles and the different retention times. Training may be adapted to suit the learning style of the employee and frequently tests them on the content so that they can easily recall the information. However, the success of adaptive learning used in educational institutes is based in part on the students having a fundamental motivation to pass their exams. As such, even though adaptive learning may offer tremendous potential to establish effective and time-efficient pathways to learn that are unique to every individual, while improving business-based outcomes, the fundamental motivation driver is missing in the corporate world. Simply incorporating adaptive learning into the workplace would not be as effective.

The modern working environment is often characterized by a group of people with varying personalities and behaviors. The challenges of corporate learning are linked with the diversity of employee personas and their lack of interest in corporate training. Indeed, there is a natural resistance towards corporate trainings.

In the corporate training ecosystem, cybersecurity is one of the most critical fields to focus on as one simple mistake by an employee can impact everyone in the company. Although the adaptive learning technology is discussed with respect to the topic of cybersecurity, the adaptive learning technology of the present disclosure will help all industries.

Prior adaptive learning technologies for corporate learning fail to address the issue of knowledge retention on an individual basis. For example, the prior technologies use a repetitive model of learning with fixed intervals for review which may not be optimal for every learner. Secondly, there is no explicit way to keep an employee motivated during their learning journey. Prior adaptive learning technologies apply a universal training delivery approach that do not cater to the different learner motivations.

The adaptive learning technology of the present disclosure provides an improvement to the prior adaptive learning technologies by providing an automated real-time customized learning experience based on a learner's profile, level of engagement and performance attributes. It incorporates the power of artificial intelligence to monitor and analyze user attributes and behaviors in the training exercises and in the real world to create a unique learning experience for each learner. The adaptive learning technology of the present disclosure also provides an improvement over the existing training delivery approach by gamifying the learning process, i.e., it will help learners to learn concepts using gamified activities. To address the problem of lack of motivation from the workforce in the corporate training, adaptive learning technology of the present disclosure will identify and associate a motivational trigger to each learner and then deliver their daily learning activities using those gamification triggers. Details on how it does this will be elaborated on below.

The adaptive learning technology of the present disclosure allows a company to develop a training program to raise skill levels or provides specific knowledge that is personalized to every single employee in real-time. Furthermore, the adaptive learning technology of the present disclosure will adaptively provide motivations to the employees to undergo such training depending on whether the employee is eager to participate or the employee expresses general apathy for the training.

The adaptive learning technology of the present disclosure is based on gamification and AI-based real-time adaptations to improve results of adaptive learning. The adaptive learning technology of the present disclosure will understand employee behavior and motivational triggers and will curate a unique learning path that will adjust itself in real-time during the learning journey of the user. The adaptive learning technology of the present disclosure will also provide reinforced learning for each learner to address the issue of knowledge retention and maintaining learning attention as the learners will be subjected to the learning content frequently.

The AI model of the present disclosure will retrain based on each action taken by an employee during their learning journey or their interactions with the real-world components (i.e. hacking attempts, phishing simulations, SIEM tools and password managers).

The real-time behavior of a learner will be tracked by ingesting data from multiple sources such as e-mail endpoint solutions, phishing simulations, password analyses, and SIEM (Security information and event management) tools. The gamification component of the AI model will also expose the learner to different motivational drivers derived from the octalysis framework and assign an optimal driver based on the learner's response to these drivers.

The AI model of the present disclosure implements an unsupervised training approach. That is, the AI model is only bound by certain rules and the limit to what it can learn is uncapped. The AI model will learn more and more as the user progresses and interacts in real-time.

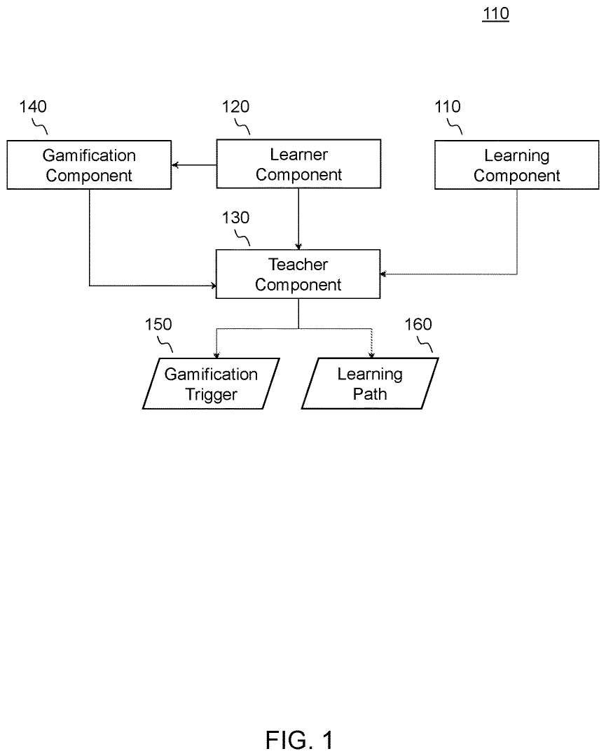

FIG. 1 illustrates a component flow diagram of a process for determining a custom learning path and a gamification trigger in accordance with various aspects of the present disclosure. Referring to FIG. 1, the system AI model includes a Learning Component (aka Expert Model) 110, a Learner Component (aka User Model) 120, a Teacher Component (aka Tutor Model) 130, and a Gamification Component (aka Gamification Model) 140. FIG. 1 provides an overview of how the components will be working with each other. For a respective learner, the Teacher Component/Tutor Model 130 receives information related to the respective learner from the 3 other models, namely the Learning Component/Expert Model 110, the Learner Component/User Model 120, and the Gamification Component/Gamification Model 140. Using the provided information, the Tutor Model 130 generates a next activity in a customized learning path 160 for the respective learner and generates a trigger 150 adapted to learning behaviors of the respective learner which is used to prompt the respective learner to undertake the next activity. In order to achieve better scalability, the User model will monitor the performance of each learner in real time. The Tutor Model will ingest learner's profile attributes, performance attributes, engagement attributes, intrinsic and extrinsic motivational drivers to define a personalized learning path that will effectively engage the learner in the training process. As the learner will progress in their learning journey, the system will auto-adjust the learning path and difficulty level for the learner.

The Expert Model 110 is configured to store and manage the content that needs to be taught. The Expert Model 110 includes a repository including the overall information of the subject matter to be taught including how the topics within the subject matter are arranged. For example, the Expert Model 110 may generate general knowledge graphs and knowledge paths that will be analyzed by the Tutor Model 130. The Expert Model 120 may provide to the Tutor Model 130 a pool of candidates for next possible activities that the respective learner can undertake from the general knowledge graph.

The User Model 120 is configured to receive, generate, analyze, and determine learner attributes. For example, the User Model 120 includes a repository include user information about each respective learner. For example, the User Model 120 may receive user information such as a respective learner's job scope. The User Model 120 may monitor and analyze how each respective learner performs activities (e.g., answer question) and updates the user information. The User Model 120 may analyze the user information and provide learner attributes to the Tutor Model 130.

The Gamification Model 140 is configured to determine a learner's motivational triggers and segment users based on those triggers. The Gamification Model 140 may receive information about each respective learner from the User Model 120. The Gamification Model 140 may use information from all the learners to determine common characteristics, behavior, or attributes among the learners and assign learners with characteristics, behavior, or attributes into one or more respective groups and determine which motivational triggers are suitable to each respective group. The Gamification Model 120 may monitor and analyze how each respective learner responds to a motivational trigger and updates the group and/or user information. The Gamification Model 140 may provide one or more group assignment information and associated group motivational trigger information to the Tutor Model 130.

The Tutor Model 130 is configured to create a customized learning path for a learner. Using the information provided from the other Models, the Tutor Model 130 will customize the learning path. For example, the Tutor Model 130 may adapt the general knowledge graph to a customized learning graph for each respective learner. For each respective learner, the Tutor Model 130 may determine a next activity to generate a personalized learning path based on a pool of candidate next possible activities from the general knowledge graph and learner attributes including current and past learner performance, etc. The Tutor Model 130 may use the information from the Gamification Model 140 to determine or update a motivational trigger of a respective learner and incentivize the learner to undertake the next activity.

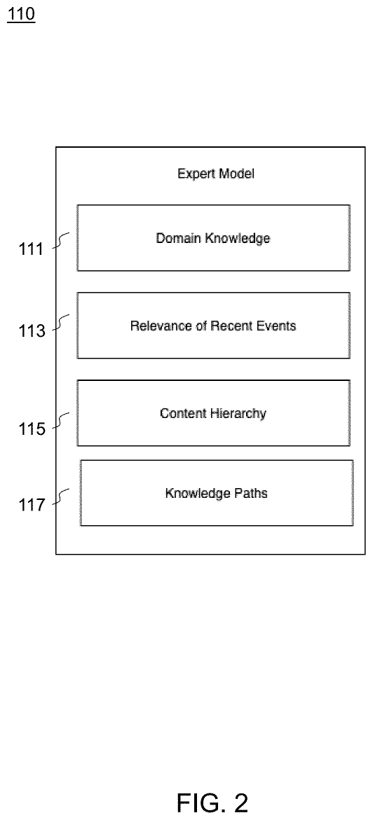

FIG. 2 illustrates a logical diagram of the Learning Component (Expert Model) 110 in accordance with various aspects of the present disclosure. The Expert Model 110 includes a repository of all training related content and possible navigation patterns. The Expert Model 110 generates a knowledge graph based on the content in the repository. Each node may represent an activity and the edges show possible navigation paths. Each activity may include the following attributes: domain, difficulty level, category, activity type. A precedence between activities may be indicated by directional edges. The precedence defines the prerequisites of any activity.

The Expert Model includes the information regarding the learning units and the paths that can be potentially taken by the user. The Expert Model may include a repository and a management interface for domain knowledge 111, a relevance of recent events 113, a content hierarchy 115, and knowledge paths 117. An administrator may be able to add/remove content or activities to/from the general knowledge graph, assign/adjust the relevance of the content/activities, assign/adjust prerequisites, and assign/adjust knowledge paths.

The Domain Knowledge module 111 includes all available activities/lessons. All learning contents/activities include information about (e.g., are tagged with) relevant domains, difficulty level, category, activity type. For example, any activity related to cybersecurity training may be tagged with a cybersecurity domain tag and anything related to Personal Data Protection Act (PDPA) or General Data Protection Regulation (GDPR) will be tagged with a Governance, Risk, Compliance (GRC) domain tag. For example, an activity type may include attribute tags indicating a lesson or quiz. For example, a category may include attribute tags indicating companies (e.g., Apple, Netflix) or software applications (e.g., Office 365, G-Suite, Hubspot).

The Relevance of Recent Events module 113 may store or include information to identify new or noteworthy. The Relevance of Recent Events database has a current knowledge of the threat landscape. This means that it will have knowledge over all the current potential threats to the cybersecurity integrity of the company. This will allow for the users to stay up to date as they can be tested on the most recent or relevant threats. For example, the Relevance of Recent Events module 113 may include information about any recent attack on the company, any new events in the geography where the company is located or induction of new process or policy in the company and identify any activities/lessons related to recent events. For example, the Relevance of Recent Events database may temporarily assign a higher weight to these activities/lessons.

The Content Hierarchy module 115 may identify the precedence of each content to make sure the system AI model will teach a learner in the sequential order of content flow and content complexity.

The Knowledge Paths module 117 may include information about the overall organization of content that we are storing in our database. The Knowledge Paths module 117 includes a general knowledge graph and knowledge subgraphs. This is basically something that has the different activities that can be taken by the user to learn a particular domain or category within the domain and how these activities relate to each other.

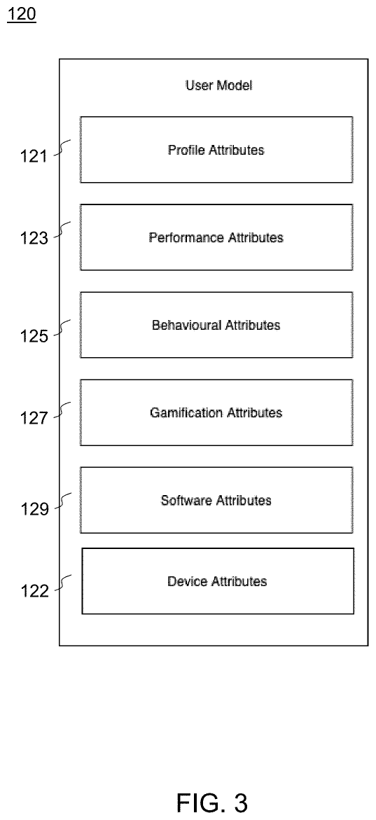

FIG. 3 illustrates a logical diagram of the Learner Component (User Model) 120 in accordance with various aspects of the present disclosure. The User Model 120 includes a repository including all information about each learner. The User Model 120 includes an AI that receives, generates, and determines various user related information that pertains to each and every learner. The User Model 120 may include a module for profile attributes 121, performance attributes 123, behavior attributes 125, gamification attributes 127, software attributes 129, and device attributes 122 of each learner.

Profile Attributes. The User Model 120 may receive, determine and/or use profile attributes 121 including, e.g., identification, title, department, office location, etc., to determine the type of knowledge and the depth of knowledge that a respective learner should know.

Performance Attributes. The User Model 120 may receive, determine and/or use performance attributes 123 including, e.g., number of attempts, time to respond, etc. to monitor the learning performance of each learner during their learning journey. For example, the User Model 120 may monitor and store a current performance of the learner and/or also retrieve and analyze a past performance of the learner.

Behavior Attributes. The User Model 120 may receive, determine and/or use behavior attributes 125 including, e.g., browsing behavior, etc. to monitor the practical performance of each learner in the real-world scenarios and to determine whether the practical performance has improved or regressed with respect to the content of the learning path. For example, the User Model 120 may monitor and store a current behavior of the learner and/or also retrieve and analyze a past behavior of the learner.

Gamification Attributes. The User Model 120 may receive, determine and/or use gamification attributes 127 including, e.g., motivational triggers, used to identify the main driving factors that will trigger the learner to complete an activity in a training module.

Software Attributes. The User Model 120 may receive, determine and/or use software attributes 129, e.g., operating system, application types, etc. to identify software applications used by each learner and their companies. The User Model 120 may use this information to prioritize content around those software applications.

Device Attributes. The User Model 120 may receive, determine and/or use device attributes, e.g., type of device, brand of device, to identify the type of devices used by the learner and/or the company. The User Model 120 may use this information to prioritize content based on the type of device (e.g. handheld phones, tablet or desktops etc.) used by the learner. It may also identify brands of these devices to provide activity visuals to match the brands as a means of customization and determining a learning path relevant to the learner.

The User Model 120 continuously observes and updates the various attributes of each user as users continue to learn. The User Model 120 may provide current and prior performance and/or behavioral attributes specific to a respective learner to the Tutor Model 130 to assist the Tutor Model 130 to customize a learning path for the respective user.

In addition to obtaining information regarding the user, the User Model 120 may also receive, generate, and determine information regarding the type of devices being used by the user. This may be done so that the activities and user interface (UI) can be customized to meet the needs of the user. For example, if the user is taking the activity from an android phone, the UI will adjust itself so it won't be using one appearance for every device.

The User Model 120 may generate for each learner a performance chart associated with the knowledge graph generated by the Expert Model 110. The User Model 120 may store an average time spent on each activity, an average number of attempts taken to answer a question or perform an activity correctly, a confidence level for each activity, and an overall activity performance score. The overall activity performance score may be determined based on the number of correct answers or actions the user has provided or performed in the provided time. The confidence level may be classified as low, medium and high. If a user is answering a question correctly and quickly the User Model 120 may consider the confidence level high, if a user is answering a question correctly but taking a lot of time to answer it, the confidence level will be considered as medium else confidence will be considered as low.

For purposes of tracking knowledge retention, the User Model 120 may determine a completion score for each activity. The completion score may be used to indicate that a learner is proficient in the activity or skill. The completion score of any activity may be a discrete score of 0 or 1 calculated using one or more of the performance attributes. For example, the confidence score may be determined based on the confidence level of an activity. If the confidence level for an activity is high, the completion score may be a 1, else a 0. The completion scores of a plurality of activities (e.g., recent and/or past activities) related to a domain or category can then be used to deduce the knowledge level of the learner in that domain or category by using a Deep Knowledge Tracing (DKT) algorithm, which is an LSTM (Long Short Term Memory) based model that considers the previous interactions of the learner. The User Model may use the DKT algorithm to use the plurality of completion scores and convert them into a vector indicating an overall progress of the learner.

For the purposes of tracking the progress of a respective learner, the User Model 120 may use the knowledge level of each domain or category to determine the skill level of the learner overall and/or in each domain or category. The User Model 120 may use the knowledge levels to determine the initial skill level of a learner and identify the strengths and weaknesses of each learner in each knowledge area. The User Model 120 may also set the difficulty level for the learner which may change as the learning journey continues for the learner. The User Model 120 may recommend one or more candidate nodes as the next step of the learner's learning path. The User Model 120 may also recommend the next review point of the learner for a particular knowledge area.

To understand the employees as a group and each individual employee better, the User Model may classify or label each learner based on their respective interactions and practices. The interactions depend on a learner's engagement in the learning program and practices depend on a learner's behavior in the real world (i.e., how the learner incorporated what was learnt).

The interactions of each learner may be determined based on information that has been collected during each learner's respective learning journey.

For example, the User Model may collect all relevant data points related to each learner's performance during a training exercise. One of more of the following data points may be collected:

Coverage. Coverage may indicate the percentage of modules a learner has completed during their learning process.

Readiness Score. Learner readiness scores are calculated based on the number of correct responses, number of iterations and the confidence value of each answer.

Average Response Time. Average response time is dependent on how quickly a learner responds to his daily notification and response time of each activity.

Self-Starter. If a learner starts training modules from the training libraries, the system will classify the learner as a self-starter.

Average Attempts. The average number of attempts the learner takes to answer an activity correctly.

For another example, the User Model may collect all relevant data points related to each learner's practices after a training exercise. The practices attributes may be calculated based on the learner's behavior in the real-time. One of more of the following data points may be collected:

Exposed to breach. The User Model may determine if the learner is in the breach datasets or an admin will mark if the learner's company has been exposed to any breach in the past.

Phishing Risk. The User Model may determine if the learner ever faced a phishing attack or performed badly in phishing simulation exercises.

Browsing Risk. The User Model may receive a classification or determine this risk attribute based on the learner's browsing behavior.

Compliance Risk. The User Model may receive a classification or determine this risk attribute based on the learner's performance in the GRC domain. For example, it can be

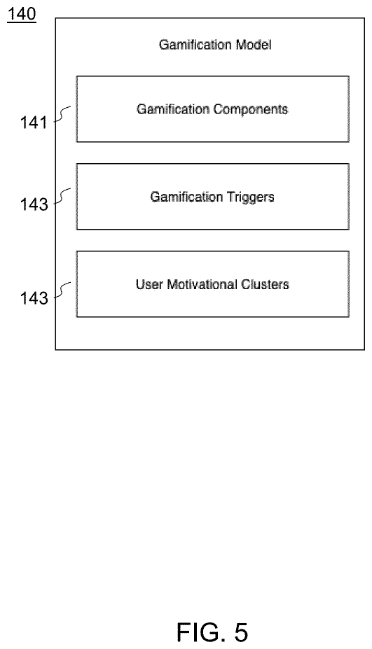

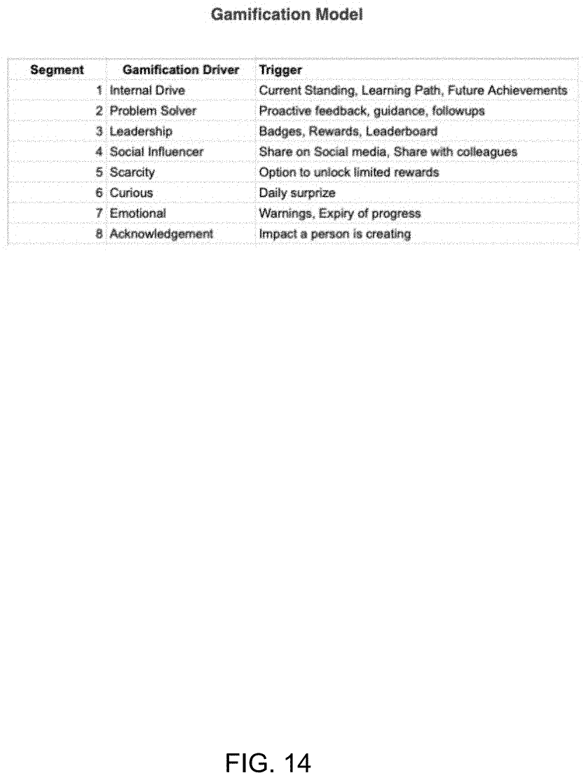

FIG. 5 illustrates a logical diagram of a Gamification Component (Gamification Model) of FIG. 1 in accordance with various embodiments. The Gamification Module 140 includes a repository of all gamification triggers that the Tutor Model 130 may use to deliver daily activities. The Gamification Model may categorize users based on their motivation using the trigger framework as shown in FIG. 14. The purpose of this is to allow for smooth operations and to get the learner to undertake the activity in the most efficient way possible. The component will constantly keep updating itself on this information as well. If the time taken for the learner to undertake the activity after the trigger has been sent out increases, the system will re-evaluate the categorization and re-categorize the employee into a new driver that is better suited for them.

To understand the employees as a group and each individual employee better, the Gamification Model may classify or label each learner based on their respective interactions and practices. The interactions depend on a learner's engagement in the learning program and practices depend on a learner's behavior in the real world (i.e., how the learner incorporated what was learnt).

The interactions of each learner may be determined based on information that has been collected during each learner's respective learning journey.

The gamification component (more detailed description will be available below) will determine the motivational driver for each learner from the eight drivers we have identified based on different attributes of learners. The learner will receive their daily lessons using those triggers.

The gamification component may consider the intrinsic and extrinsic motivation factors of learners and classify them into at least one of the eight segments of the Octalysis framework proposed by Yu-Kai Chou.

Using these motivational drivers as a reference, the AI will test each learner against all drivers and assign the most optimal trigger for future learning exercises.

In some examples, the Gamification Model uses the gamification model of Octalysis as a baseline. Initially, the gamification engine may try all gamification drivers with each learner and identify one or more drivers that elicit a maximum response from the learner. Such drivers will be tagged to the learner profile for future iterations. The gamification drivers and triggers are summarized in the table illustrated in FIG. 14.

Since a learner can respond to multiple drivers, our system is using the AI-enabled clustering mechanism (e.g. K-means clustering) to tag users based on the nearest cluster. The Gamification Model 140 may receive information about each respective learner from the User Model 120. The Gamification Model 140 may use information from all the learners to determine common characteristics, behavior, or attributes among the learners and assign learners with characteristics, behavior, or attributes into one or more respective groups and determine which motivational triggers are suitable to each respective group. The Gamification Model 120 may monitor and analyze how each respective learner responds to a motivational trigger and updates the group and/or user information. The Gamification Model 140 may provide one or more group assignment information and associated group motivational trigger information to the Tutor Model 130.

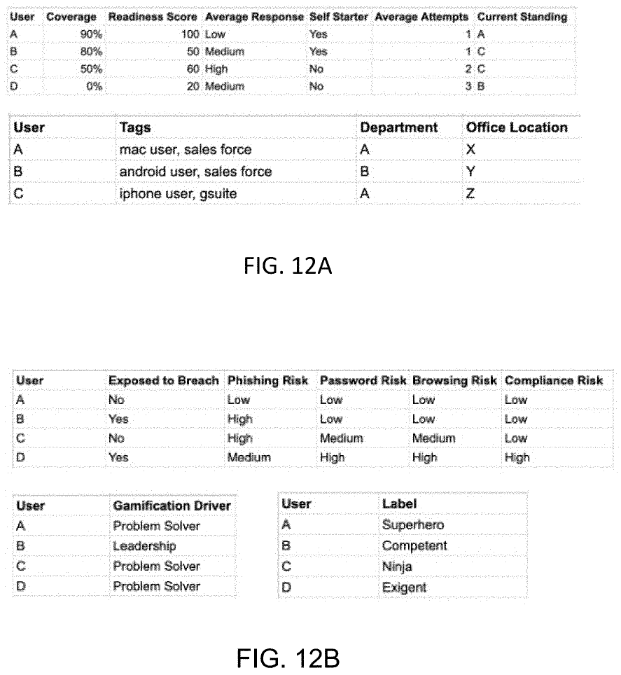

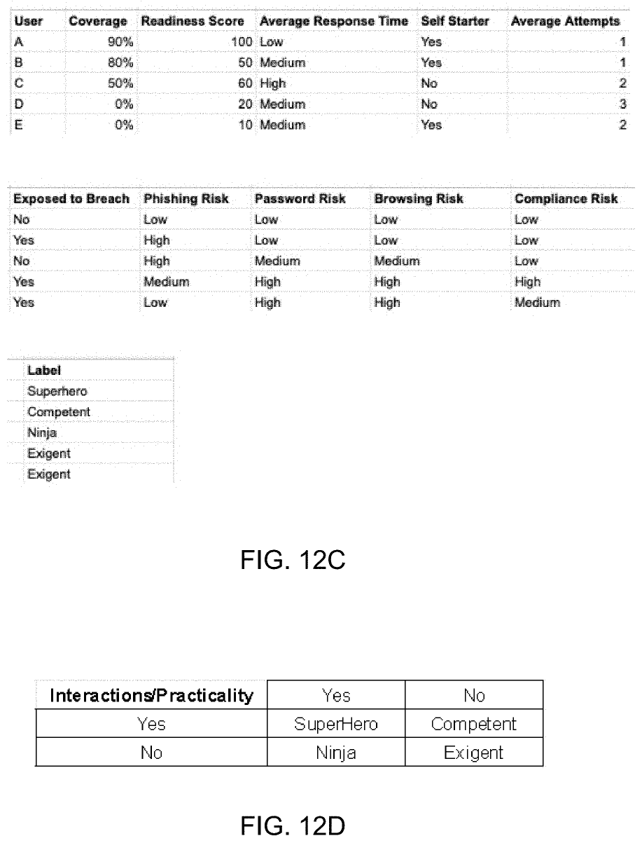

For example, user attributes including one or more of the following: a learner's coverage, readiness score, average response time, self-starter status, average attempts, exposure to breach, phishing risk, browsing risk, and compliance risk, may be passed into a Machine Learning model of the User Model to predict the persona of each learner. In some examples, a Decision Tree Classifier may be used. In some examples, in general, any other classification technique might be used. As shown in the table of FIG. 12D, the personas may be assigned based on the assessments on the learner's interactions and practices.

The User Model may be trained so that a learner who proactively interacts with the learning program and keeps the real-time security scenarios resolved is tagged as a “SuperHero” and vice versa for other personas as mentioned in the matrix above. For example, a learner having coverage greater than 70% shows good interaction with the learning program while at the same time the learner having a high phishing risk indicates the learner is not implementing what is learned. The system will mark such learners as Competent.

With information regarding the personas of the employees/learners, the company can better adapt to the personas present in the workforce and can also help the CISO (Chief information security officer) to mitigate the risks as they would know where each employee is lacking.

In some examples, the Gamification Model may make use of the technique of gamification in order to keep the learner engaged. For example, an octalysis gamification model may be used in order to gamify the unique learning path for the learners. The octalysis model includes 8 drivers (more details on the driver is given below) which may encourage a learner in order to perform an activity. In some embodiments, the learner may be assigned a random trigger initially and the effectiveness of this trigger will be analyzed by monitoring the learner's engagement as a result of the trigger. If the learner is engaged because of the trigger, the trigger will be deemed as effective and if the learner is not engaged after the trigger is sent, it will be marked as not effective and the learner will be engaged using another trigger.

The learners may be clustered based on these triggers. The implication of this is that all learners in the same cluster will have similar triggers. There would be a cluster for every driver and so there would be 8 different clusters which are shown in the table of gamification trigger classifiers illustrated in FIG. 14.

In some examples, once the Gamification Model has already matured with other learner's gamification data, these clusters may be used for assigning a trigger to a new learner that starts learning, rather than assigning a random trigger initially to a new learner. For the new learner, a suitable cluster may be found and a trigger for that cluster will be chosen for the learner. For example, if a user is a new user, the Gamification Model will try all available gamification driver types to the user each day to see what gamification driver type received the quickest response from the learner. If a user will show the same response for multiple clusters it will narrow down those triggers and try shortlisted triggers to see what will show a consistent behavior from the learner. This gives a meaningful start to the gamification for that learner. Subsequently, the Gamification Model can alter the gamification triggers of that learner based on the effectiveness of the gamification trigger as described above.

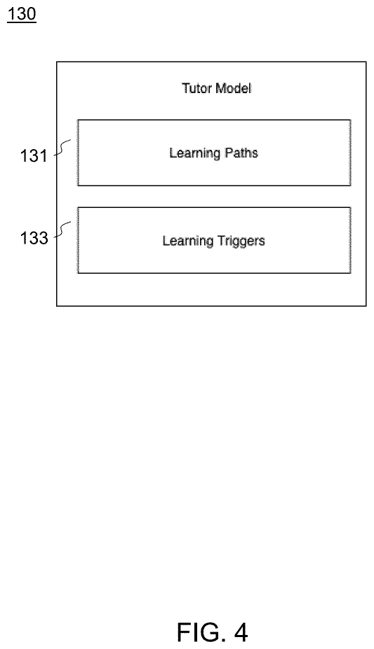

FIG. 4 illustrates a logical diagram of the Teacher Component (Tutor Model 140) in accordance with various aspects of the present disclosure. The Tutor Model 140 determines a custom learning path and gamification trigger for each respective learner. The Tutor Model 140 incorporates the learner's existing knowledge, difficulty level and topic diversity to suggest a training activity that will help learners either to maintain their existing knowledge or add a new dimension in their knowledge repository.

The Tutor Model 130 receives from the User Model 120 various user specific attributes of the learner, including the learner's profile attribute information, their current standing, and existing progress information. The Tutor Model 130 uses the information provided by the User Model 120 to determine optimum learning paths that a learner can take. That is, the Tutor Model 130 may receive the information collected by the User Model 120 and Expert Model 110 and use the information to determine the next activity for a learner.

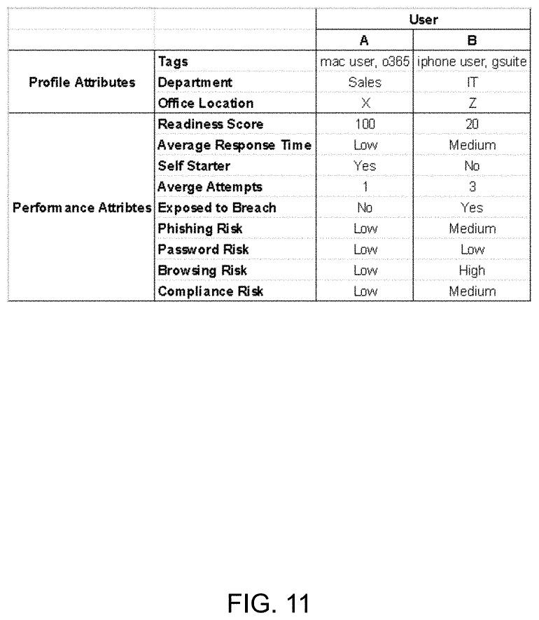

One or more of these attributes may be used to determine a relevancy of an activity or node with respect to a particular learner. The Tutor Model 130 may determine the relevancy of an activity or node while querying for the possible paths from the Expert Model 110. For example, the Tutor Model 130 may use profile attributes, such as department and office location, to determine whether a candidate activity in the general knowledge graph is relevant to a particular learner. Table 1 in FIG. 11 shows attributes maintained for two learners.

Referring to Table 1 in FIG. 11, a Tutor Model 130 evaluating whether an activity related to “secure coding practices” is relevant to learner B may access the profile attribute of learner B to determine learner B's department. The Tutor Model 130 may determine that learner B is from the software engineering IT department, and therefore this indicates that the activity related to “secure coding practices” is relevant to learner B and should be selected as a candidate activity in order to know the threats related to insecure coding practices. Referring again to Table 1, the Tutor Model 130 may determine that the same activity is not relevant to learner A since learner A is in the sales department.

The performance and behavior attributes play an important role in the decision of the next selected activity for the learner. A high confidence level during the learning journey and less involvement in any malicious activity will create a smooth learning path for a learner where there will be fewer reviews (e.g., repeated exposures) of the activity. However, if a learner either shows poor performance in learning activities or shows risky behavior in real world applications, the learner will be exposed to multiple reviews (e.g., repeated exposures) of the content of an activity/node until the learner masters that concept. That is, this aspect relates to maintaining knowledge retention with spaced learning.

For example, this determination may be based on a process that uses reinforcement learning techniques of Artificial Intelligence to determine the next optimal learning activity for the learner.

For example, in connection with determining an optimum learning path for a learner, the Tutor Model 130 may determine a review frequency of prior content or activities based on the learner's performance in the activity. The Tutor Model 130 may use a spaced learning algorithm to minimize the number of reviews while maintaining knowledge retention.

Initially, the probability of forgetting an item is assigned to each item using a simple Exponential Forgetting Curve model based on the difficulty level of each activity. Each attempt of the user is recorded along with the accuracy that the user has achieved. This data is stored by the user module.

The algorithm adjusts this forgetting curve for each user for each item accordingly based on the attempts and their results. It tries to keep the number of reviews as minimum as possible while optimizing the interval between reviews under given time duration.

An activity is exposed again when the user is about to forget the item as calculated from the adaptive forgetting curve.

This way the effectiveness of spaced repetition technique is utilized while making it adaptive for each user. After each attempt the forgetting curve is adjusted accordingly. In case the user attempts the activity correctly its probability of forgetting is made lower and vice versa. If the user attempts the activity correctly, the next revision would be at a greater interval and if the user performs incorrectly, the revision frequency would increase

One possible model of reinforcement learning may be an actor-critic model. In this approach, the actor model may choose an activity and the critic model may monitor a learner's response for that activity. When the critic determines that the selected activity was a mistake, it can penalize the actor model and adjust it for future iterations. If the critic determines the selected activity was qualified, it will enhance recommendation policy determined by the actor model.

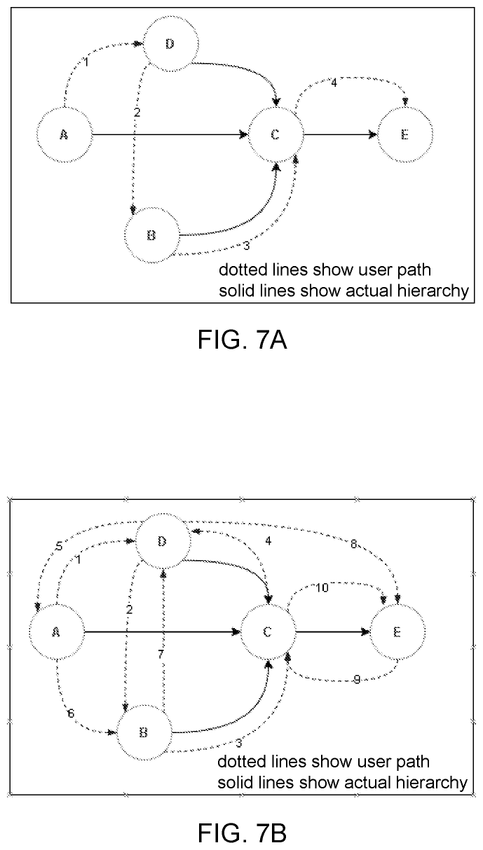

FIGS. 7A and 7B illustrate examples of knowledge graphs and customized learner paths in accordance with various aspects of the present disclosure. Referring to FIG. 7A, learner A is showing good performance in the activities and has never shown any malicious behaviors so the risk score will be lower. In contrast, learner B is having a difficult time attempting the activities and implementing them practically. Based on the one or more candidate next activities presented by the User Model 120 to the Tutor Model 130, the Tutor Model 130 may select for learner A the candidate next activity corresponding to a simpler more direct path, so that learner A may cover all relevant activities while minimizing the number of estimated reviews. An example path for learner A is shown in FIG. 7A using dotted lines. With respect to learner B, the Tutor Model 130 may select for learner B the candidate next activity corresponding to a more complicated loop path, so that learner B may be provided repeated exposures to problematic activities. That is, the Tutor Model 130 may recommend more reviews of the same activity and set it as a prerequisite to ensure learner B masters the content. An example path for learner B is shown in FIG. 7B using dotted lines.

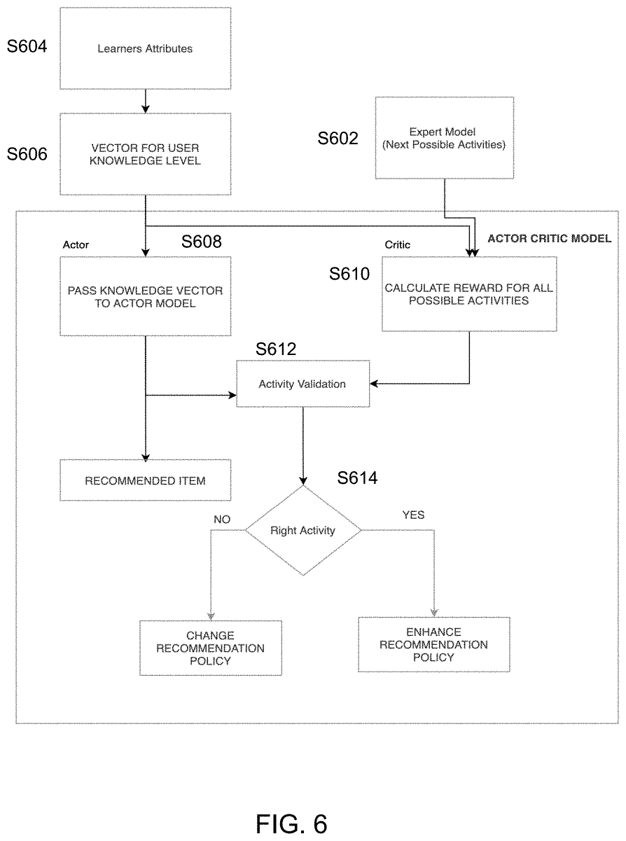

FIG. 6 illustrates a more detailed logical flow diagram of a process for determining a learning path in accordance with various aspects of the present disclosure. In particular, FIG. 6 relates to an actor-critic model of the Tutor Model 130. In some examples, the tutor model utilizes an actor-critic approach when it recommends an activity to the learner. When recommending, the tutor model considers all activities that are similar to the activities that the learner has just completed and these become candidate activities. The actor-critic model is the one that chooses from this pool of candidates, the next activity that the learner will undertake.

An actor model assigns a probability distribution for each of the candidate activities. This probability distribution is formed by combining knowledge level and the target activity. The activity with the highest probability is selected as the next activity. A critic model validates the results generated by the actor. It computes the distance for each candidate activity and rewards them. The shorter the distance, the greater the reward. The activity with the highest reward is selected as the one that will minimize the shortest path to get to the target activity. The actor is rewarded and enhanced if the suggested activity from the critic matches that of the actor. Otherwise, the actor is penalized and the activity suggested from the critic is used.

FIG. 6 illustrates the process that will be taken in order to recommend an activity to the user. The Tutor Model of the present disclosure will apply deep knowledge tracing to the obtained user attributes and assign a vector for the current knowledge level. This will be provided to the actor model. The actor model will formulate a recommendation that will be reviewed by the critic model. If the activity is appropriate the actor model will enhance its recommendation policy and if the activity is incorrect the actor model will change the recommendation policy. After taking into the feedback, the item will be recommended.

The Tutor Model considers an accuracy of an answer, an amount of time taken to respond, a confidence level and number of iterations a learner has taken to master a particular concept. The activities may be time-bound activities. The benefits of time-bound activities include but are not limited to an increase in efficiency and an increase in focus which is a key benefit we want to achieve in corporate learning.

Referring to FIG. 6,

At S602, the Expert Model 110 provides next possible activities (i.e., a pool of candidate activities) to the Tutor Model 130. For example, the Expert Model 110 may receive information related a learner's current progress and determine a current node of the user relative to the general knowledge graph and may analyze the edges from the current node of the user to determine the next nodes and possible paths for the learner. The Expert Model 110 may provide one or more of these nodes as candidates to the Tutor Model 130.

At S604, the User Model 120 retrieves learner attributes from the database.

At S606, the User Model 120 generates a vector indicating a user knowledge level. For example, given the activity performance, the User Model 120 may provide a vector that depicts the user knowledge level. The vector may be determined using the DKT algorithm. The vector may refer to an overall mastery level of all knowledge areas (e.g., one or more domains or categories), for all the activities performed by the user.

At S608, the actor model of the Tutor Model 130 receives the next possible activities that the learner can attempt provided by the Expert Module 110. The actor model selects an activity from the pool of candidate activities as the recommended activity based on a recommendation policy. Initially however, the actor model may not have an effective recommendation policy. It may use a random recommendation policy to choose an activity at random. However, if a persona has been determined for the learner, the actor model may select a flow or one of the next activities provided by the Expert Model that best matches with the persona of the learner. For example, there may be two next possible activities where one activity is identified as relating to the finance department and the other activity is identified as relating to the IT department. If the User Model provides a persona for a user. The actor model may use the persona of the user to select an initial activity. It is through the feedback given by the critic model that the recommendation improves. The recommendation policy is used by the Tutor Model 130 to recommend the next activity. The recommendation basically becomes more adept as the feedback received increases.

At S610, the critic model of the Tutor Model 130 receives the vector and the pool of candidate next possible activities. The critic model attempts to validate the candidate generated by the actor model. The critic model may assess whether the selection is correct. Thereafter, a recommendation policy may be evolve based on evaluating one or more vectors related to various learner attributes. For example, the critic model computes a distance for each candidate next possible activity in the pool and calculates a reward based on the distance where the reward may be inversely proportional to the distance. Based on the user knowledge level represented by the vector, the critic model may validate whether the recommended activity was correct or not by comparing each reward relative to the vector. An activity may be correct for example if the activity would minimize the length of the path to a target activity. If the recommended activity was correct the recommendation policy of the Tutor Model will be kept. Otherwise, if the activity recommended was incorrect, the recommendation policy will be altered.

At S612, the recommended activity selected by the Actor Model is compared to the candidate next possible activities evaluated by the Critic Model.

At S614, the Tutor Model 130 determines whether the Actor recommended the right activity. If the Actor recommended the right activity then the recommendation policy is enhanced, however if the Actor recommends the wrong activity then the recommendation policy is changed.

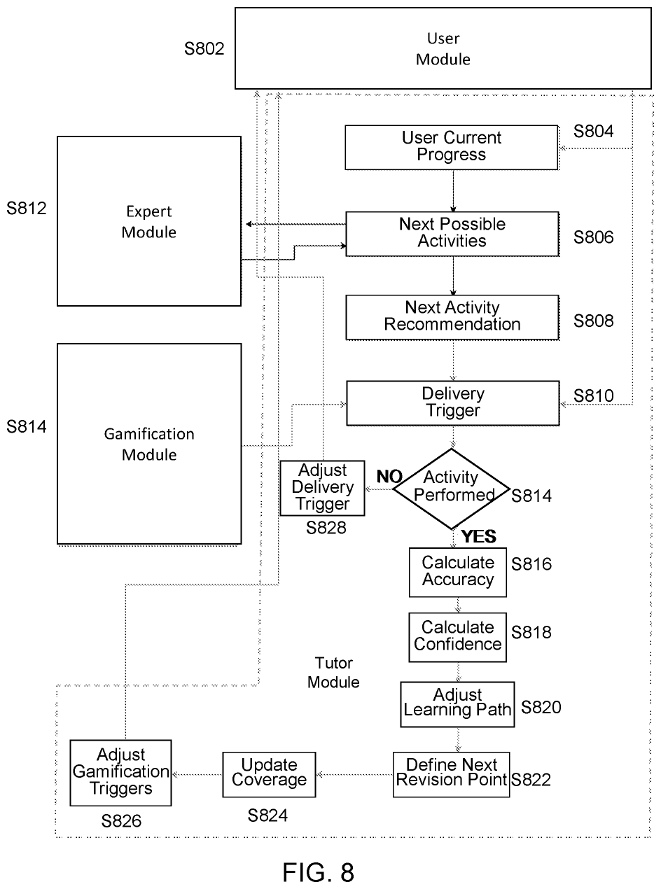

FIG. 8 illustrates a more detailed logical flow diagram of a process for determining a learning path and a gamification trigger in accordance with various aspects of the present disclosure.

At S802, the User Model will contain the repository of knowledge it has on the profile, performance, behavior and gamification attributes of a learner. The User Model calculates the users' knowledge level and will use this to determine their overall skill level and identify their strengths and weaknesses. It will help to set the difficulty level for the learner, as the learning journey continues.

At S804, the information from the User Model is passed over to the Expert Model and the Tutor Model and is used to determine the current progress of the user.

At S806, the Expert Model will provide the next possible activities that the user could undertake. The Expert Model considers the current progress of the user as given by the User Model.

At S810, since the User Model contains knowledge on the gamification attributes of a learner, the delivery trigger will be based on that information. The delivery trigger is chosen and will be issued to the user to get them to undertake the activity.

At S812, the Expert Model will contain a repository of all training related content and possible navigation patterns. The Expert Model will convert its content repository to knowledge graph, where each node will represent an activity and edges will show possible navigation paths. The Expert Model will provide possible candidate paths that the user could take.

At S814, the Gamification Model will contain all of the 8 different drivers. Based on the information obtained by the User Model, the appropriate gamification trigger will be chosen and is what will be used to engage the user. Subsequently, the software checks if the activity is performed or not. If the activity is performed, proceed to the next step as everything is effective so far. If the activity is not performed, the Tutor Model will re-evaluate the trigger and feed the information to the Gamification Model to update its knowledge of the user.

At S816, the Tutor Model will calculate the accuracy of the user, that is, whether or not they have accurately performed the activity. That is, how successfully a user has repeatedly completed the activity or skill.

At S818, the Tutor Model measures the confidence level by checking whether the learner has answered correctly and by observing the time taken by the learner to complete the activity.

At S820, based on the results observed in S818, the Tutor Model will adjust the learning path. If the software feels the learner is confident enough, it will move onto the next activity. If the software feels that the learner still has to learn or become more confident, it will make them review the concepts more.

At S822, the Tutor Model will define the next review point. This is when the learner will be exposed to the same concept again so as to make them more familiar with it and improve their retention of the concepts.

At S824, the Tutor Model will update the status for all the activities taken by the user. If the user learns something new the coverage will increase and if the user is revising something then the coverage remains the same.

At S826, the adjustment in gamification triggers takes place. The software will analyze whether or not the user is being motivated enough by the trigger (by looking at whether or not they take up the activity) and will improve the triggers.

At S828, if the user has not performed the activity even after the trigger was delivered, the system will re-evaluate whether or not the trigger was effective. It will adjust the delivery trigger so as to be better suited for the learner and will present the same content with the new delivery trigger.

Once the activity is recommended to the learner and has been successfully attempted by the learner. The next step is to identify when the learner should review the same content in order to retain this information for a longer period of time. The Tutor Model 130 implements a concept of spaced learning for these review exercises to flatten the forgetting curve of a learner.

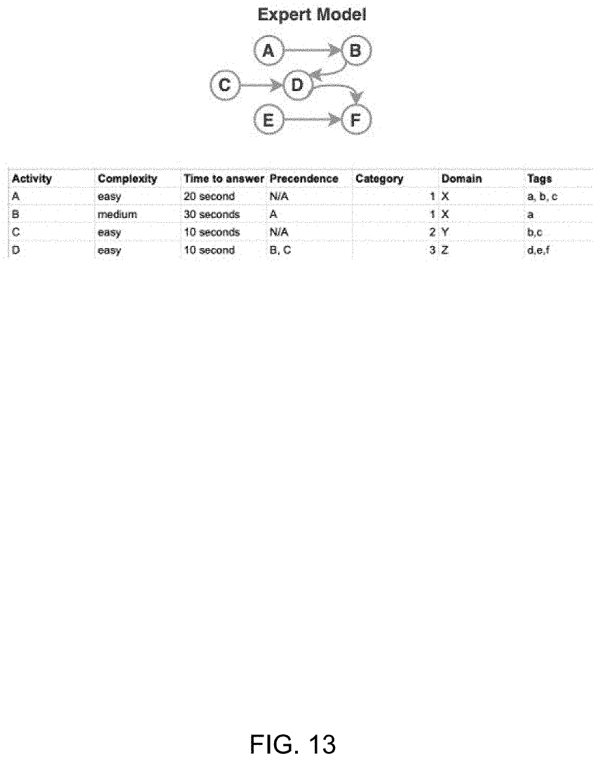

The process of determining a learning path and a gamification trigger in accordance with various aspects of the present disclosure may involve managing content data, user data, and gamification data to be used by a machine learning model. Such data may be arranged in databases. FIG. 11 illustrates a table showing attributes maintained for two learners by the User Model. FIGS. 12A-D illustrate tables showing attributes maintained by the User Model. FIG. 13 illustrates a graph and table showing a general knowledge graph and activity attributes maintained by the Expert Model. FIG. 14 illustrates a table showing gamification drivers and associated triggers maintained by the Gamification Model.

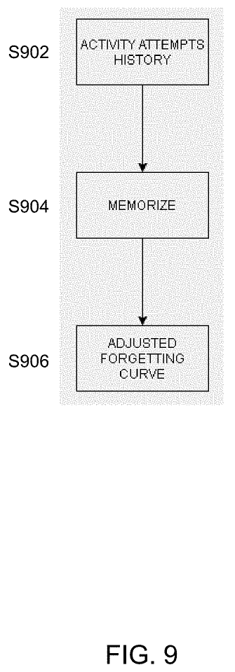

FIG. 9 illustrates a logical flow diagram of a process for determining a review schedule in accordance with various aspects of the present disclosure. In some examples, the Tutor Model 130 may identify when the learner should repeat an activity that they have successfully attempted. The repetition may reduce the probability of the user forgetting what was learned. In order to accomplish this, a spaced learning approach is utilized where an activity is repeated at intervals. Conventional systems use spaced learning with static buckets or heuristics to define the repetition interval criteria for each learner. However, these approaches do not adapt to a learner's ability and knowledge. The Tutor Model implements an improved space learning approach by dynamically adjusting the repetition criteria for each learner.

Initially, the probability of forgetting an item may be assigned to each item using a simple Exponential Forgetting Curve model based on the difficulty level of each activity. Each attempt of the learner is recorded along with the accuracy that the learner has achieved. The algorithm adjusts this forgetting curve for each learner for each item accordingly based on the attempts and their results. It tries to keep the number of times an item is repeated (e.g., by providing helpful feedback if the user attempted the activity incorrectly) as minimum as possible while optimizing the interval between repeated exposures/review under given time duration.

This way the effectiveness of spaced repetition technique is utilized while making it adaptive for each learner. An activity is exposed again when the learner is about to forget the item as calculated from the adaptive forgetting curve. After each attempt the forgetting curve is adjusted accordingly. In case the learner attempts the activity correctly its probability of forgetting is made lower and vice versa.

The probability of forgetting is inversely proportional to the number of reviews a learner is assigned. The probability of forgetting a particular concept for a learner depends on accuracy of the learner's answers. A correct answer will reduce the number of reviews needed however answering an activity incorrectly will result in increasing the number of reviews required for that activity.

In order to create an optimal learning path, we are using a reinforcement model that will analyze learner performance metrics, engagement metrics and profile attributes in real time and use actor-critic technique to define next learning activity for the learner.

The AI model will also consider the type of device the customer is using and what software application learner and learner's company is using. The AI model will prioritize scenarios that will be relevant to the learner environment and also customize the UI to suit the device being used. This is done so as to allow for smoother gameplay and to reduce any potential inefficiencies.

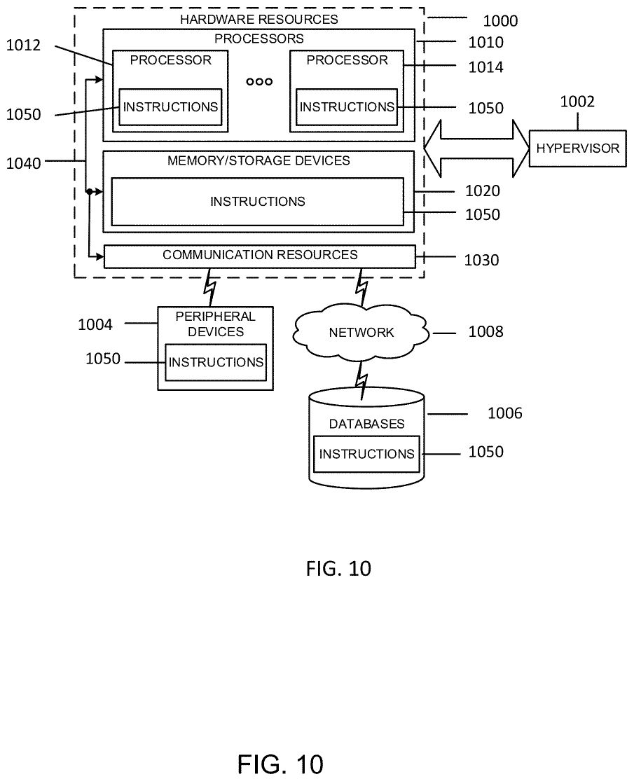

FIG. 10 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 10 shows a diagrammatic representation of hardware resources 1000 including one or more processors (or processor cores) 1010, one or more memory/storage devices 1020, and one or more communication resources 1030, each of which may be communicatively coupled via a bus 1040. For embodiments where node virtualization (e.g., NFV) is utilized, a hypervisor 1002 may be executed to provide an execution environment for one or more network slices/sub-slices to utilize the hardware resources 1000.

The processors 1010 may include, for example, a processor 1012 and a processor 1014. The processor(s) 1010 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1020 may include main memory, disk storage, or any suitable combination thereof. The memory/storage devices 1020 may include, but are not limited to, any type of volatile or nonvolatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1030 may include interconnection or network interface components or other suitable devices to communicate with one or more peripheral devices 1004 or one or more databases 1006 via a network 1008. For example, the communication resources 1030 may include wired communication components (e.g., for coupling via USB), cellular communication components, NFC components, Bluetooth® (or Bluetooth® Low Energy) components, Wi-Fi® components, and other communication components.

Instructions 1050 may include software, a program, an application, an applet, an app, or other executable code for causing at least any of the processors 1010 to perform any one or more of the methodologies discussed herein. The instructions 1050 may reside, completely or partially, within at least one of the processors 1010 (e.g., within the processor's cache memory), the memory/storage devices 1020, or any suitable combination thereof. Furthermore, any portion of the instructions 1050 may be transferred to the hardware resources 1000 from any combination of the peripheral devices 1004 or the databases 1006. Accordingly, the memory of processors 1010, the memory/storage devices 1020, the peripheral devices 1004, and the databases 1006 are examples of computer-readable and machine-readable media.

### Examples

Example 1 is a system configured to teach users by providing gamified real-time adaptive learning path to each user, the system including a communication interface, and one or more processors coupled to the communication interface and configured to:

receive a set of nodes and directed edges connecting the nodes that represent a general knowledge graph;

receive user attribute information;

organize users based on the user attribute information into groups based on a plurality of gamification driver types and associate at least one gamification trigger to each gamification driver type;

determine information related to a current knowledge level of the user, including the user's current node and current skill level;

determine a set of candidate nodes from the set of nodes, the set of candidate nodes selected based on the nodes connected to the user's current node with respect to the general knowledge graph;

use a neural network to select one node from the set of candidate nodes based on the current knowledge level of the user;

provide the node to the user with at least one gamification trigger;

determine, when the user performs an activity associated with the node, performance attributes related to the activity;

update the current knowledge level of the user based on the performance attributes; and

adapt the learning path of the user based on the current knowledge level.

Example 2 may include the system of Example 1, wherein the one or more processors configured to determine information related to the current knowledge level of the user are further configured to:

generate a vector representing a user's knowledge level.

Example 3 may include the system of Example 2, wherein the one or more processors configured to use a neural network to select one node from the set of candidate nodes based on the current knowledge level of the user are further configured to:

select the one node based on a recommendation policy;

determine a validity of the selected one node; and

adjust the recommendation policy when the selected one node is invalid or maintain the recommendation policy when the selected one node is valid.

Example 4 may include the system of Example 3, wherein the one or more processors configured to use a neural network to determine the validity of the selected one node are further configured to

calculate a reward for each candidate node in the set of candidate nodes; and

compare each reward to the vector representing a user's knowledge level.

Example 5 may include the system of any one of Examples 1-4 and 7-20, wherein the one or more processors are further configured to:

determine a persona of the user based on the user's user attribute information including performance and behavior attributes.

Example 6 may include the system of Example 5, wherein the one or more processors are further configured to:

adapt the learning path of the user based on the determined persona of the user.

Example 7 may include the system of any one of Examples 1-4 and 8-20, wherein the one or more processors are further configured to:

receive or determine information about an environment of the user including user attribute information related to at least one of the following: devices used by the user and applications frequently used by the user;
adjusting the learning path of the user based on the user attribute information related to the environment of the user.

Example 8 may include the system of any one of Examples 1-7 and 9-20, wherein the set of candidate nodes is selected based on the flow paths connected to the user's current node with respect to the general knowledge graph.

Example 9 may include the system of any one of Examples 1-8 and 10-20, wherein the general knowledge graph represents all the training content and all possible navigation paths.

Example 10 may include the system of any one of Examples 1-9 and 11-20, wherein each node includes a difficulty level, domain tag, and recent event tag.

Example 11 may include the system of any one of Examples 1-7, wherein the activity is time-bound and/or interactive.

Example 12 may include the system of Example 11, wherein the one or more processors configured to determine, when the user performs an activity associate with the node, performance attributes related to the activity are further configured to:

determine an accuracy value the user with respect to the activity, wherein the accuracy value represents how successfully the user has completed the activity.

Example 13 may include the system of Example 12, wherein the one or more processors configured to determine, when the user performs an activity associate with the node, performance attributes related to the activity are further configured to:

measure a time taken by the learner to attempt or complete the activity; and

determine confidence level based on the accuracy of the activity and time taken by the user to attempt the activity.

Example 14 may include the system of Example 13, wherein the one or more processors configured to adapt the learning path of the user based on the current knowledge level are further configured to:

determine a completion score based on the confidence level, wherein the completion score is used to determine whether a node is repeated to the user.

Example 15 may include the system of Example 14, wherein the one or more processors configured to adapt the learning path of the user based on the current knowledge level are further configured to:

adjust a difficulty level of the learning path.

Example 16 may include the system of Example 15, wherein the one or more processors configured to adapt the learning path of the user based on the current knowledge level are further configured to:

determine a probability of forgetting content associated with the selected one node using a simple Exponential Forgetting Curve model based on the difficulty level of the activity.

Example 17 may include the system of Example 16, wherein the one or more processors are further configured to:

monitoring the number of attempts and the accuracy of the activity; and

adjusting the forgetting curve after each attempt.

Example 18 may include the system of Example 17, wherein the one or more processors are further configured to:

assign an interval between repeating the activity;

increase the interval with each successful attempt at the activity or decrease the interval with an unsuccessful attempt at the activity.

Example 19 may include the system of any one of Examples 1-18, wherein the one or more processors are further configured to:

adjust, when the user ignores the activity, the at least one gamification trigger.

Example 20 may include the system of Example 19, wherein the one or more processors configured to adjust, when the user ignores the activity, the at least gamification trigger are further configured to:

select another gamification trigger associated with the gamification driver type.

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by means of communication including through a wire or other interconnect connection, through a wireless communication channel or ink, and/or the like.

The term “information element” refers to a structural element containing one or more fields. The term “field” refers to individual contents of an information element, or a data element that contains content.

What is claimed:

1. A system configured to teach users by providing gamified real-time adaptive learning path to each user, the system including a communication interface, and one or more processors coupled to the communication interface and configured to:
receive a set of nodes and directed edges connecting the nodes that represent a general knowledge graph;
receive user attribute information;
organize users based on the user attribute information into groups based on a plurality of gamification driver types and associate at least one gamification trigger to each gamification driver type;
determine information related to a current knowledge level of the user, including the user's current node and current skill level;
determine a set of candidate nodes from the set of nodes, the set of candidate nodes selected based on the nodes connected to the user's current node with respect to the general knowledge graph;
use a neural network to select one node from the set of candidate nodes based on the current knowledge level of the user;
provide the node to the user with at least one gamification trigger;
determine, when the user performs an activity associated with the node, performance attributes related to the activity;
update the current knowledge level of the user based on the performance attributes; and
adapt the learning path of the user based on the current knowledge level.

2. The system of claim 1, wherein the one or more processors configured to determine information related to the current knowledge level of the user are further configured to:
generate a vector representing a user's knowledge level.

3. The system of claim 2, wherein the one or more processors configured to use a neural network to select one node from the set of candidate nodes based on the current knowledge level of the user are further configured to:
select the one node based on a recommendation policy;
determine a validity of the selected one node; and
adjust the recommendation policy when the selected one node is invalid or maintain the recommendation policy when the selected one node is valid.

4. The system of claim 3, wherein the one or more processors configured to use a neural network to determine the validity of the selected one node are further configured to
calculate a reward for each candidate node in the set of candidate nodes; and
compare each reward to the vector representing a user's knowledge level.

5. The system of claim 1, wherein the one or more processors are further configured to:
determine a persona of the user based on the user's user attribute information including performance and behavior attributes.

6. The system of claim 5, wherein the one or more processors are further configured to:
adapt the learning path of the user based on the determined persona of the user.

7. The system of claim 1, wherein the one or more processors are further configured to:
receive or determine information about an environment of the user including user attribute information related to at least one of the following: devices used by the user and applications frequently used by the user;
adjusting the learning path of the user based on the user attribute information related to the environment of the user.

8. The system of claim 1, wherein the set of candidate nodes is selected based on the flow paths connected to the user's current node with respect to the general knowledge graph.

9. The system of claim 1, wherein the general knowledge graph represents all the training content and all possible navigation paths.

10. The system of claim 1, wherein each node includes a difficulty level, domain tag, and recent event tag.

11. The system of claim 1, wherein the activity is time-bound and/or interactive.

12. The system of claim 11, wherein the one or more processors configured to determine, when the user performs an activity associate with the node, performance attributes related to the activity are further configured to:
determine an accuracy value the user with respect to the activity, wherein the accuracy value represents how successfully the user has completed the activity.

13. The system of claim 12, wherein the one or more processors configured to determine, when the user performs an activity associate with the node, performance attributes related to the activity are further configured to:
measure a time taken by the learner to attempt or complete the activity; and
determine confidence level based on the accuracy of the activity and time taken by the user to attempt the activity.

14. The system of claim 13, wherein the one or more processors configured to adapt the learning path of the user based on the current knowledge level are further configured to:
determine a completion score based on the confidence level, wherein the completion score is used to determine whether a node is repeated to the user.

15. The system of claim 14, wherein the one or more processors configured to adapt the learning path of the user based on the current knowledge level are further configured to:
adjust a difficulty level of the learning path.

16. The system of claim 15, wherein the one or more processors configured to adapt the learning path of the user based on the current knowledge level are further configured to:
determine a probability of forgetting content associated with the selected one node using a simple Exponential Forgetting Curve model based on the difficulty level of the activity.

17. The system of claim 16, wherein the one or more processors are further configured to:
monitoring the number of attempts and the accuracy of the activity; and
adjusting the forgetting curve after each attempt.

18. The system of claim 17, wherein the one or more processors are further configured to:
assign an interval between repeating the activity;
increase the interval with each successful attempt at the activity or decrease the interval with an unsuccessful attempt at the activity.

19. The system of claim 1, wherein the one or more processors are further configured to:
adjust, when the user ignores the activity, the at least one gamification trigger.

20. The system of claim 1, wherein the one or more processors configured to adjust, when the user ignores the activity, the at least gamification trigger are further configured to:
select another gamification trigger associated with the gamification driver type.
